(19) United States
(12) Patent Application Publication
(10) Pub. No.: US 2016/0019225 A1
(43) Pub. Date: Jan. 21, 2016

(54) Methods for Normalizing Encoding Formats of Digital Assets

(71) Applicant: Lexmark International Technology, SA, Meyrin (CH)

(72) Inventor: Bruce Yang Wang, Leawood, KS (US)

(21) Appl. No.: 14/800,377

(22) Filed: Jul. 15, 2015

Related U.S. Application Data
(60) Provisional application No. 62/024,874, filed on Jul. 15, 2014.

(51) Int. Cl. G06F 17/30

(52) U.S. Cl. CPC G06F 17/30076; G06F 17/30781; G06F 17/30117

(57) ABSTRACT

A method of normalizing digital formats comprises determining a plurality of digital files associated with a user, the plurality of digital files having a plurality of encoding formats; generating a script based on a set of encoding formats predetermined for the plurality of digital files; and based on the generated script, performing at least one of creating and deleting a digital file to conform the plurality of encoding formats to the set of predetermined encoding formats.

### CROSS REFERENCE TO RELATED APPLICATIONS

The present application is related to and claims priority from U.S. provisional patent application 62/024,874, filed Jul. 15, 2014, entitled, “METHODS FOR NORMALIZING ENCODING FORMATS OF DIGITAL ASSETS,” the content of which is incorporated by reference herein its entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates generally to normalizing files, and more particularly to automatically normalizing encoding formats of digital files to conform to a standard set of predetermined encoding formats specified by a user.

2. Description of the Related Art

Digital files, such as videos, audio, text documents, and images, need to be managed by media management systems as they may create a bulk of unnecessary information if left unorganized. Similar to books, different versions or renditions of a particular digital file may be created for different uses. For example, a single video may be rendered in two encoding formats, such as in an .MP4 or .AVI format, which may depend on the nature or environment of the system it will be loaded in.

In a multi-tenant system, a single instance of an application may run on a server of a media management organization for delivery to a plurality of customers or tenants. Since a single instance of an application is being shared by customers, there is a problem in delivering application data relevant to customers as the customers may receive data in a format they may not have a use for. While filtering digital files associated with a customer's account in the system may be done automatically, standardizing each digital file to conform to the customer's needs presents a drawback. There may be a need to manually convert each file to have an encoding format desired by each customer and/or manually eliminate files that do not comply with the customer's needs or requests prior to delivery to the customer.

Moreover, the volume of digital files that a customer owns typically increases over time. New rules for delivering files may also eventually be required by the customers from their host or from the media management organization. Other changes may also occur such as, for example, when encoding formats of files previously requested by the customer to may no longer be supported or when some file encoding formats become obsolete. In these instances, some of the digital files associated with a customer's account may need to be removed, while a different encoding format may be needed for the remaining files. In this example scenario, constantly and repeatedly adjusting a customer's digital files each time new customer rules are received poses a problem to the media management organization.

Accordingly, there is a need for a system and method for automatically normalizing a current collection of digital files to conform to a predetermined set of encoding formats which may be requested by the user. There is also a need for dynamically normalizing a customer's most current set of digital files each time a new set of encoding formats is requested.

### SUMMARY

Methods for normalizing digital file formats are disclosed. One example method of normalizing digital formats includes determining a plurality of digital files associated with a user, the plurality of digital files having a plurality of encoding formats; generating a script based on a set of encoding formats predetermined for the plurality of digital files; and based on the generated script, performing at least one of creating and deleting a digital file to conform the plurality of encoding formats to the set of predetermined encoding formats.

A second example method of automatically standardizing digital file formats includes receiving a set of encoding formats predetermined for use in a plurality of digital files associated with a user, the plurality of digital files having a plurality of encoding formats; and executing a script based on the set of predetermined encoding formats for: (i) determining whether one or more predetermined encoding formats is missing from the plurality of encoding formats and upon a positive determination, creating a digital file for each of the one or more missing predetermined encoding formats; and (ii) identifying whether a digital file of the plurality of digital files associated with the user has an encoding format not included in the set of predetermined encoding formats and upon a positive identification, eliminating the digital file from the plurality of digital files associated with the user, wherein the executing is performed to automatically standardize the plurality of encoding formats with the set of predetermined encoding formats.

Other embodiments, objects, features and advantages of the disclosure will become apparent to those skilled in the art from the detailed description, the accompanying drawings and the appended claims.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows one example embodiment of a system for normalizing encoding formats of a plurality of content assets based on a set of predetermined encoding formats for receipt by corresponding customers.

FIG. 2 shows a flowchart of one example method for normalizing a plurality of content assets based on a set of predetermined encoding formats.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents.

The following description is therefore, not to be taken in a limited sense, and the scope of the present disclosure is defined by the appended claims.

Also, it is to be understood that the phraseology and terminology used herein is for the purpose of description and should not be regarded as limiting. The use herein of “including”, “comprising”, or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure to include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

Disclosed are a system and methods for normalizing a plurality of encoding formats of a customer's content assets to conform to a set of predetermined encoding formats. Normalizing may include creating one or more content assets having encoding formats that comply with the set of predetermined encoding formats and deleting content assets/s that do not comply. Other rules and processes may be applied in any part of the normalization to process and will be further described below.

For purposes of the present disclosure, a content object may refer to a collection of digital files. Digital files may be divided into types, which may be, for example, a particular video, audio, image, logo, and/or a combination of digital file types (i.e., a multimedia file) among others. As is known in the art, each digital file type may adhere to a standard set of encoding formats. An encoding format may refer to a specialized file format in which a digital file may be rendered for transmission or storage to a specific computing system or environment. For example, an encoding format of an image file may be in JPEG, PNG, BMP, TIFF, or GIF encoding format; an audio file may be in MP3, AIFF, WMA, or WAV encoding format; while a text file or document may be rendered or encoded in ASCII, UTF-8, or Unicode encoding format, among others.

In other example embodiments, an encoding format may refer to a combination of parameters or settings in which a digital file is rendered in. For example, an encoding format for a video content asset may be a combination of container, codec, bit rate, and other settings typical in video encoding. A video file may thus have the following encoding format: “avi” container, “xvid” video codec, and “mp3” audio codec operating at a data transfer rate of 1000 kilobyte per second (kbps). The encoding format may also be, for example, a particular compression algorithm or a character encoding protocol used to render a digital file. Other encoding formats or digital file formats standard for a digital file type are known in the art.

In the present disclosure, a content object may include one or more content assets. In one example embodiment, a content object may refer to a group of a particular type of digital file, such as a collection of image files. In this example embodiment, a content asset may refer to a specific rendition of a digital file. For example, a “video” content object may include a video A: a first video A is rendered in AVI encoding format while a second video A is rendered in MPEG. Video A in an AVI encoding format and video A in MPEG encoding format may be two examples of content assets for video content object A. In another example embodiment, a content object may refer to a particular multimedia file. In this example embodiment, the content asset may refer to one or more digital files or sections that make up the specific rendition of a digital file. In the same example, video A may be rendered in an AVI encoding format and may contain both audio and video files, as is typical in a multimedia file. The audio file and video file of video A may each be referred to as a content asset.

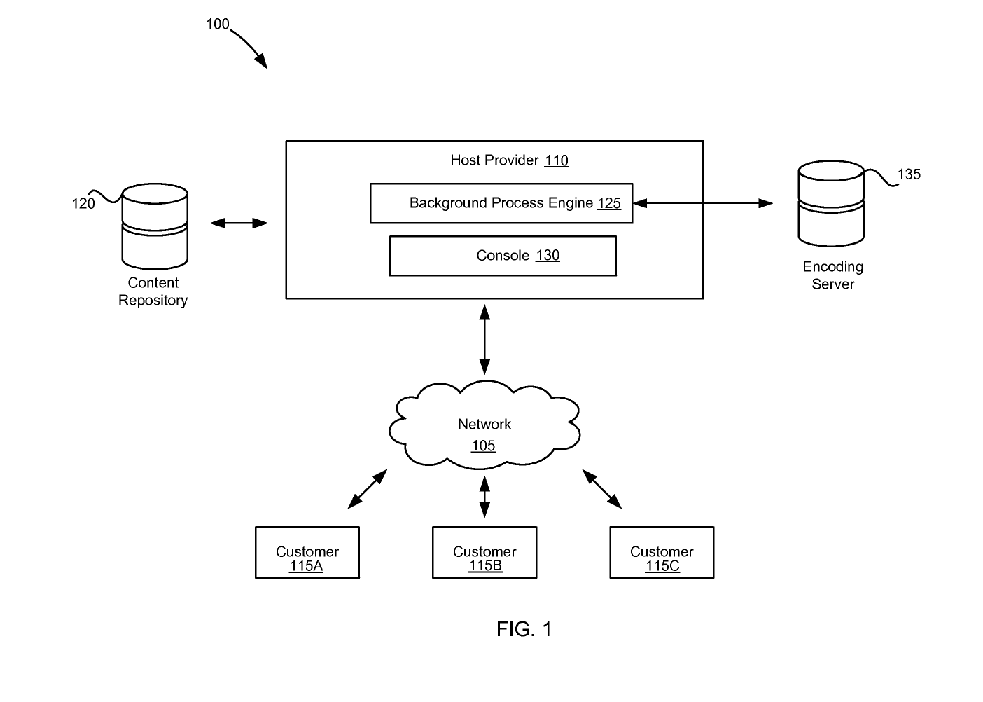

FIG. 1 shows one example embodiment of a system 100 for normalizing encoding formats of content assets to conform to a predetermined set of encoding formats. System 100 may be a system including a network 105 and a host provider 110 communicatively coupled with a plurality of customers 115A, 115B, and 115C through network 105. System 100 may be a multi-tenant system having an application such as a console 130 shared by host provider 110 and customers 115A, 115B, and 115C. The predetermined set of encoding formats may be a set of encoding formats specified by any of customer 115A, 115B, and 115C to host provider 110 and/or may be according to a nature or policy of the customer's respective businesses or of the host provider's.

Network 105 may be any network capable of allowing communications between two or more computing systems, as discussed herein and/or available or known at the time of filing and/or developed after the time of filing. For example, network 105 may be a communications network or network/communications network system such as, but not limited to, a peer-to-peer network, a hybrid peer-to-peer network, a Local Area Network (LAN), a Wide Area Network (WAN), a public network such as the Internet, a private network, a cellular network, or a combination of different network types. Network 105 may be a wireless, a wired, and/or a wireless and wired combination network.

Host provider 110 may be any organization or company that provides an application and/or solution for managing digital or media files to a plurality of customers such as customers 115A, 115B, and 115C. Host provider 110 may provide a secured data storage for access by each of customers 115A, 115B, and 115C and/or may charge each of the customers a certain value depending, for example, on a type of a subscription package. Host provider 110 may be managed by, for example, a technical administrator having an administrator or base account which may be used to manage one or more customer accounts. Host provider 110 may be communicatively connected to a content repository 120 having data or content such as a plurality of content assets for use and access by corresponding customers 115A, 115B, and 115C.

Customers 115A, 115B, and 115C may be users or companies subscribing or utilizing the application and/or solution provided by host provider 110. Customers 115A, 115B, and 115C may require a data storage system provided by host provider 110, such as content repository 120. Customers 115A, 115B, and 115C may possess respective one or more content objects with associated content assets for storing on content repository 120 provided by host provider 110. The set of content objects and content assets associated with to each of customers 115A, 115B, and 115C may be accessed through a web application, such as console 130, provided by host provider 110. Each of customers 115A, 115B, and 115C may have an account on console 130.

In one example embodiment, at least one of customers 115A, 115B, and 115C may be a reseller. Customers 115A, 115B, and/or 115C may sell the application and/or solution provided by host provider 110 for managing media files of another set of customers. For example, customer 115A may provide to customers A, B, and C the application and/or solution provided by host provider 110. As is typical for resellers, reselling customer 115A may customize the application and/or solution subscribed from host provider 110 for distribution to customers A, B, and C. Customizing the application and/or solution provided by host provider 110 may include, but may not be limited to, adding other services related to the application and/or solution provided by host provider 110.

Content repository 120 may be a storage mechanism for storing a plurality of content objects (e.g., video, image, and audio content object) each including a plurality of digital files in different renditions, i.e., content assets. Content repository 120 may be a persistent storage mechanism for storing one or more files and may be, for example, a computing device including a memory for storing and/or retrieving data, files, or content. Content repository 120 may be, for example, a database server, for storing content that may be accessed by host provider 110. Content on content repository 120 may be managed in a separate and/or shared database process, separate and/or shared machine, and/or separate and shared database tables depending on how content repository 120 is configured. Configuration's on content repository 120 may also be dependent on a policy or nature of host provider 110 or an associated customer. For example, customer 115A may have a set of terms agreed with host provider 110 to have different database servers for each content object since customer 115A may have a website in need of a storage area for a large quantity of content objects and assets.

The plurality of content assets stored on content repository 120 may include a source asset and one or more converted assets. A source asset may refer to a digital file first uploaded and stored on content repository 120 by host provider 110 or any of customers 115A, 115B, and 115C. On the other hand, a converted asset may refer to a digital file uploaded after the source asset, which may have a digital file type and content the same as that of the source asset but of different encoding format. The converted asset may also refer to the source asset converted in another encoding format. For example, customer 115A may upload a first instance of a video A in AVI format to content repository 120. Customer 115A may request host provider 110 for the same video but in MPEG format. One or more computer program instructions on host provider 110 may be configured to produce a video A in MPEG format (converted asset) by converting the source asset.

With reference still on FIG. 1, host provider 110 may include a background process engine 125 having one or more computer program instructions for performing one or more operations associated with normalization, such as, but not limited to, retrieving content assets from content repository 120, determining a set of predetermined encoding formats for the content assets and normalizing the content assets to conform with the set of predetermined encoding formats.

Since content in content repository 120 may be persistent, background process engine 125 may include any programming technique or framework (e.g., object relational mapping framework) for providing a layer of abstraction for interacting with content repository 120 without altering the data in it. Content in content repository 120 may not be recognized by host provider 110; however, through background process engine 125, host provider 110 may communicate with content repository 120 regardless of how the content repository is structured or coded.

Background process engine 125 may be communicatively coupled with one or more encoding servers 135 for converting a digital file from one encoding format to another or to a content asset. Background process engine 125 is shown on FIG. 1 as encapsulating a functionality of host provider 110. However, background process engine 125 may be a program function or a set of instructions abstracted for managing, specifically, normalizing a plurality of content assets of a customer which may be performed as part of or in association with elements on system 100.

Host provider 110 may also include console 130 for access by host provider 110 and customers 115A, 115B, and 115C for managing a plurality of content assets, such as in a file library. Managing content assets may include, but are not limited to, displaying content objects and associated content assets from content repository 120, storing a content asset to content repository 120, specifying a delivery mechanism for the content objects and assets, customizing a storage mechanism for one content object to another, and filtering content assets. It may be apparent to those skilled in the art that the management of content objects to and assets by a customer such as customer 115A may depend on or become limited to the policies or terms agreed with host provider 110 upon subscription to system 100. For instance, customer 115A may have a different set of managing capabilities than customer 115B.

Console 130 may be a user interface having one or more computer program instructions for allowing host provider 110 and/or its corresponding customers for managing content assets. Console 130 may be, for example, a web application, for accessing by host provider 110 and customers 115A, 115B, and 115C. Console 130 may include graphical user interface elements or functional features as in a typical web application or page, such as buttons, links, tables, and lists, for performing one or more business logic associated with managing content objects and assets.

Other modules or functional units besides background process engine 125 and console 130 may also be included in host provider 110. Further, it will be appreciated by those skilled in the art that functions may be performed by the elements in system 100 even if not performed in modular model.

One or more encoding servers 135 may be any computing device including one or more computer program instructions for converting or encoding a particular digital file to a predetermined encoding format. Examples of encoding server may include but are not limited to, a personal computer, a server computer, a series of server computers, a mini computer, and a mainframe computer. One or more encoding servers 135 may also be a web server (or a series of web servers) for receiving one or more parameters, settings, and other data needed for encoding a digital file. One or more encoding servers 135 may be one or more third-party servers communicatively coupled with host provider 110 through a network such as network 105 for receiving a digital file for conversion and sending or storing the converted digital file or content asset, as will be described in detail below. Each of the one or more encoding servers 135 may be appropriate for converting a particular digital file type.

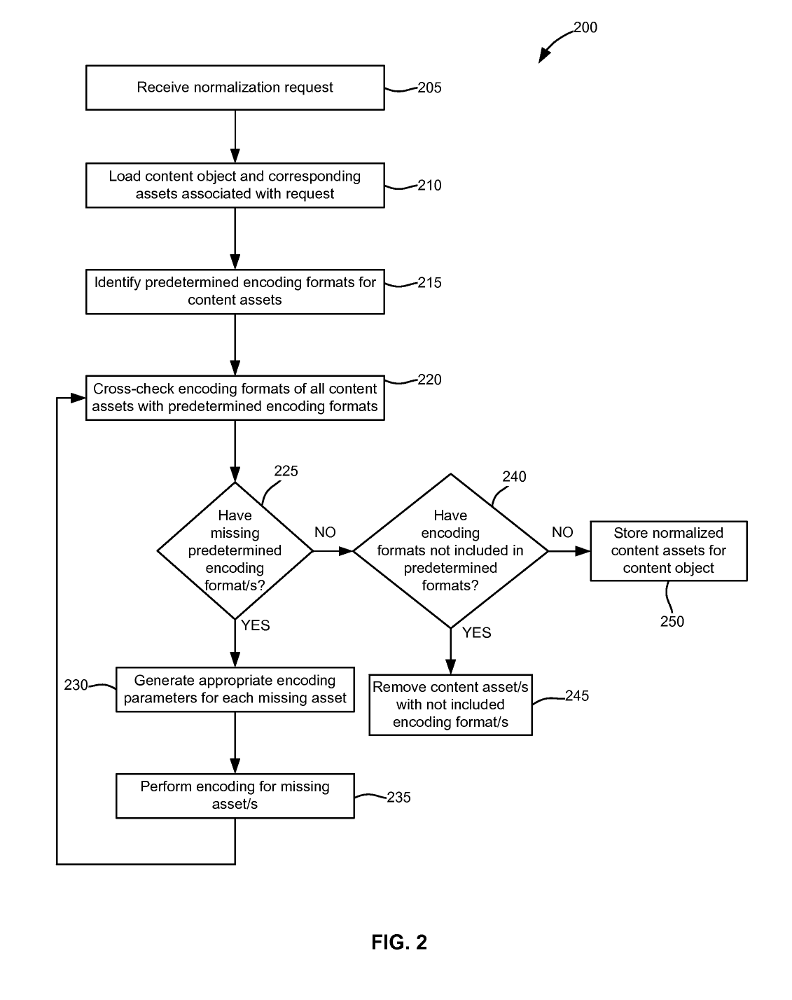

FIG. 2 shows one example flowchart of a method 200 for normalizing a plurality of content assets associated with a user, according to one example embodiment. Steps of method 200 may be performed by background process engine 125 of system 100 for delivering a normalized set of content assets to the requesting customer or requestor. However, the same steps may be performed on any system having a content repository and a need for normalizing content, as is apparent in the art.

At block 205, host provider 110 may receive a request from a customer such as customer 115A for normalizing a plurality of content assets associated with the customer. The request may be delivered by the customer through an e-mail message, but other communication methods may be utilized, such as, for example, a phone call, a personal chat, a snail mail, and the like. In one example embodiment, the request may indicate a set of encoding formats for the content objects and assets associated with the customer making the request. The content objects and assets associated with the requesting customer may be the content objects and assets linked to his or her account in system 100. For example, host provider 110 may receive a request from customer 115 indicating a need for all images (content object) to have JPEG, GIF, and PNG encoding formats.

In another example embodiment, the request may specify a content object or a set of content assets to be normalized. One or more content objects or assets specified for normalization may be for/from a specific reseller, company, library, or a set of digital files predetermined by the customer, among others. For example, customer 115A may notify host provider 110 of a need to convert all images encoded in JPEG into the PNG encoding format and then delete all GIF images. In another example, customer 115A may be a reseller having a base account or an account similar to and provided by host provider 110. Customer 115A, for example, may indicate to host provider 110 to delete a “pic.jpeg” image on the accounts of customers A, B, and C as well as any other content related to the image (e.g., a video having the image to be deleted therein).

In yet another example embodiment, the request may also indicate one or more custom rules specified by a particular customer in normalizing a plurality of content assets, such as, for example, a range of date coverage for the digital files to be normalized, duplication of content assets, or a custom schedule for normalizing (creating and deleting) digital files, among others. For example, customer 115A may request host provider 110 to delete all digital files created or uploaded five years before regardless of a type of content object, create a duplicate copy for each image content asset, or normalize digital files associated with his or her account every three (3) years, respectively. Other rules for dynamically normalizing digital files associated with a customer's account may be apparent in the art.

Upon receipt of this request, at block 210, background process engine 125 may determine content/s necessary for normalizing and retrieve them from content repository 120. to The one or more rules indicated by the customer in the request may be considered in the collection of content objects and associated assets.

For example, customer 115A may indicate to host provider 110 through a request of a need to normalize all the videos that it owns or are associated with its account under host provider 110 according to a new set of encoding formats. Background process engine 125 may collect all content assets under “video” content object that are tied with or linked to the account of customer 115A. In one example embodiment, an identifier of customer 115A or his/her associated content assets on content repository 120 may be used to retrieve all the videos under his or her account regardless of the encoding format.

At block 215, upon collecting content associated with the customer's request, a standard set of encoding formats for the collected digital files may be identified. Identifying a standard set of encoding formats for the loaded digital files may include determining an identifier corresponding to each of the encoding formats in the standard set specified by the customer. The identifier of each encoding format in the standard set may be indicative of a characteristic inherent for each encoding format, such as, for example, a globally unique identifier (GUID) for referencing one or more parameters or settings inherent for a particular encoding format. The identifier may be, for example, a database primary key referencing the one or more encoding parameters of an encoding format which may be used in converting a digital file from one format to another.

In the present disclosure, host provider 110 may not be compatible to or recognized by content repository 120. Background process engine 125 may provide a layer for executing an executable code or shell script for accessing content repository 120. Background process engine 125 may include one or more instructions or a coding pattern for converting data from content repository 120 (e.g., database objects such as content objects and assets) for recognition by host provider 110 (or display on console 130), such as, for example, the Active Record pattern. As such, upon collection of the digital files associated with the request and identifying the encoding formats as well as the custom rules indicated by the customer in normalizing, background process engine 125 may generate one or more scripts for performing one or more operations associated with the normalization process. The one or more operations may include, but are not limited to, content asset creation and content asset deletion.

A script may be a set of instructions or program code for performing an operation on a collection or set of content assets, such as those assets collected by one or more instructions on background process engine 125 at block 210. The script may be written in any programming language and may be generated on background process engine 125. It may be, for example, a web service call or any other coding mechanisms that execute program code or a set of executable instructions for creating or deleting a content asset. One example for a script is a “rake script” on Ruby or Rails applications. The script may be executed at one time and directed to the collected content assets associated with the customer requesting for normalization. In one aspect, the script may be executed on a shell, i.e., a user interface component of content repository 120, for example.

A script may be generated depending on the operation to be executed. For example, one script may be executed for determining which encoding formats are missing from the customer's current content assets and another script may be generated and executed for deleting content assets having encoding formats not compliant with the predetermined set of encoding formats or rules set by the requesting customer. In one example embodiment, a script for cross-checking encoding formats of the customer's content assets to the encoding formats requested by the customer may be generated and executed. This way, background process engine 110 may determine which content assets may need to be created or deleted to normalize a customer's set of content assets.

At block 220, the script for cross-checking encoding formats may be executed. Upon cross-checking the encoding formats, background process engine 125 may determine whether a set of predetermined encoding formats are missing from the customer's current content assets or not (block 225).

Upon determining that there are encoding formats in the requested set of encoding formats missing from the encoding formats in the collected set of content assets, appropriate encoding parameters for creating the missing content assets may be generated at block 230. Another script may be executed for generating the encoding parameters for creating a content asset. The script, for example, may determine an identifier of each of the missing encoding formats for retrieving the one or more encoding parameters to be used in encoding.

The one or more encoding parameters generated may be utilized for creating the missing content assets (block 235). The one or more encoding parameters may be a set of metadata needed for conversion, such as, for example, a specific container, codec, bit rate, to compression type, and/or language-specific character encoding protocol. The digital file used for the process of conversion or encoding may be a source asset.

In one example embodiment, creating a new content asset at block 235 may include sending the one or more encoding parameters to an appropriate server among one or more encoding servers 135 for converting a digital file from one encoding format to another and thus creating a new content asset for the content object. For example, one or more encoding parameters for encoding an image may be sent to an encoding server for encoding an image file. In another example embodiment, creating the new content asset based on the missing encoding formats from the predetermined set may be scheduled, such as in a queue. For example, it may be determined at block 220 that 100 encoding formats are missing from the customer's current set of content assets. Creating a content asset for each of the missing encoding formats may be scheduled according to an estimated length of time that it takes to perform the conversion, for example.

A newly-created content asset may be stored on the same storage location as that of the content object it is corresponding to or on the same storage location as that of the content assets it is associated with prior to the conversion. However, in other example embodiments, a different storage location may be specified by host provider 110.

Until it is determined at block 225 that all encoding formats in the set specified or requested by the customer are accounted for, it is then determined whether there are encoding formats in the customer's collection of objects and assets that are not included in the set (block 240). If so, the content assets having those encoding formats are then removed from the customer's current collection of content assets at block 245. A script may also be generated and executed to perform the removal of content assets having encoding formats not included in the customer's specified set.

In one example embodiment, the removal or deletion of content assets not included in the predetermined set may be scheduled on a regular basis. For example, content assets having encoding formats specified by customer 115A to be deleted may be permanently removed or unlinked from the account of customer 115A on system 100 every five (5) years. The scheduled removal or deletion may also be specified by host provider 110 or the customer.

In another example embodiment, deleting the content assets may be dependent on to the custom rule/s set upon by host provider 110 or the requesting customer, such as a deletion of obsolete encoding formats. Prior to deletion, the content assets may be marked or identified to be deleted. For example, a script may be executed to identify which content assets may be deleted and upon such identification, marks the content assets for deletion. The script may add an identifier to a metadata of a content asset to identify the content asset to be deleted. A deletion script scheduled to execute on a yearly basis, for example, may collectively delete the content assets marked to be removed. The marked content assets may be removed permanently from content repository 120.

While the creation of content assets (blocks 230-235) precede the removal of content assets (blocks 240-245) in FIG. 2, it may be apparent for those skilled in the art that the removal of content assets may be performed prior to the creation of new content assets, in another example embodiment. Another removal operation may then be performed by another script. Since a script may be generated using the predetermined set of encoding formats specified by the customer and based on the operation to be performed, the creation and the removal of content assets may be performed as independent processes and one may not necessarily rely upon the other. However, creating and removing content assets based on the predetermined or specified set of encoding formats may both be needed to be performed in order to produce or store a normalized collection of content assets associated with a customer's account, as indicated at block 250.

It will be appreciated that the actions described and shown in the example flowcharts may be carried out or performed in any suitable order. It will also be appreciated that not all of the actions described in FIG. 2 needs to be performed in accordance with the example embodiments and/or additional actions may be performed in accordance with other example embodiments of the disclosure.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of normalizing digital file formats, comprising:
determining a plurality of digital files associated with a user, the plurality of digital files having a plurality of encoding formats;
generating a script based on a set of encoding formats predetermined for the plurality of digital files; and
using the generated script, performing at least one of a creation and a deletion of a digital file for conforming the plurality of encoding formats to the set of predetermined encoding formats.

2. The method of claim 1, wherein the performing the creation of the digital file includes creating a digital file having an encoding format corresponding to a predetermined encoding format missing from the plurality of digital files associated with the user.

3. The method of claim 2, wherein the performing the creation of the digital file includes determining a unique identifier for each predetermined encoding format missing from the plurality of digital files associated with the user for use in the creation.

4. The method of claim 2, wherein the performing the creation of the digital file includes determining one or more encoding parameters associated with the predetermined encoding format missing from the plurality of digital files associated with the user.

5. The method of claim 2, wherein the performing the deletion of the digital file is executed after performing the creation of the digital file having the encoding format for conformity to the set of predetermined encoding formats.

6. The method of claim 1, wherein the performing the deletion of the digital file includes removing a digital file from the plurality of digital files associated with the user, the digital file having an encoding format not included in the predetermined set of encoding formats.

7. A method of automatically standardizing digital file formats, comprising:
receiving a set of encoding formats predetermined for a plurality of digital files associated with a user, the plurality of digital files having a plurality of encoding formats; and
executing a script based on the set of encoding formats for performing at least one of:
creating a digital file having a predetermined encoding format missing from the plurality of encoding formats of the plurality of digital files associated with the user; and
eliminating a digital file from the plurality of digital files associated with the user having an encoding format not included in the predetermined set of encoding formats,
wherein executing the script is performed to automatically standardize the plurality of encoding formats of the plurality of digital files with the set of predetermined encoding formats.

8. The method of claim 7, wherein the creating the digital file includes converting a copy of a digital file from the plurality of digital files associated with the user to have the missing predetermined encoding format.

9. The method of claim 7, wherein the creating the digital file includes identifying one or more encoding parameters associated with the predetermined encoding format.

10. The method of claim 7, wherein the executing the script for eliminating the digital file is performed at a predetermined frequency.

11. The method of claim 7, further comprising storing a standardized plurality of digital files.

12. The method of claim 7, wherein the eliminating the digital file from the plurality of digital files associated with the user is performed after creating a digital file for each predetermined encoding format missing from the plurality of encoding formats of the plurality of digital files associated with the user.

13. The method of claim 7, wherein the executing the script includes cross-checking the predetermined set of encoding formats with the plurality of encoding formats of the plurality of digital files associated with the user for one of a missing predetermined encoding format for use in digital file creation and an encoding format from the plurality of digital files of the user not included in the predetermined set for removal.

14. A non-transitory computer-readable storage medium having computer-executable instructions for:
determining, based on a predetermined set of encoding formats for a plurality of digital files having a plurality of encoding formats and associated with a user, at least one of:
a first digital file to be created, the first digital file having an encoding format corresponding to a predetermined encoding format missing from the plurality of encoding formats; and
a second digital file included in the plurality of digital files to be removed, the second digital file having an encoding format not included in the predetermined set of encoding to formats; and
executing a first script for creating the first digital file and a second script for removing the second digital file from the plurality of digital files associated with the user.

15. The non-transitory computer-readable storage medium of claim 14, wherein a copy of a digital file associated with the user having content associated with the first digital file is encoded to create the first digital file.

16. The non-transitory computer-readable storage medium of claim 15, wherein the instructions for executing the first script for creating the first digital file includes instructions for communicating one or more settings of the first digital file to an encoding server for creating the first digital file.

17. The non-transitory computer-readable storage medium of claim 14, wherein the plurality of digital files associated with the user include one digital file being a combination of a plurality of other digital files associated with the user.

18. The non-transitory computer-readable storage medium of claim 14, wherein the plurality of digital files associated with the user include one or more videos.

19. The non-transitory computer-readable storage medium of claim 14, wherein the plurality of digital files associated with the user include one or more images.

20. The non-transitory computer-readable storage medium of claim 14, wherein the plurality of digital files associated with the user include one or more text documents.
